(19) United States
(12) Patent Application Publication
(10) Pub. No.: US 2009/0010193 A1
(43) Pub. Date: Jan. 8, 2009

(54) SYSTEM AND METHOD OF MULTICASTING MULTIMEDIA STREAMS

(76) Inventor: Santosh Kolenchery, Cary, NC (US)

Correspondence Address: ERICSSON INC., 6300 LEGACY DRIVE, M/S EVR 1-C-11, PLANO, TX, 75024, US

(21) Appl. No.: 11/774,295

(22) Filed: Jul. 6, 2007

(51) Int. Cl. H04H 1/00

(52) U.S. Cl. 370/312

(57) ABSTRACT

A method and system for multicasting a media stream in a telecommunications network. The system includes a broadcast user broadcasting a media stream. The broadcast user determines the destination addresses of each end user desiring to receive the media stream. The media stream is received by an IP router. Within a classification stage of a data-plane residing in the IP router is a replication filter action which replicates the broadcast media stream. The broadcast media stream is replicated with the exception of the destination address. The replicated media stream is sent to each destination address of the end users, thereby providing a multicast media stream to a plurality of end users without requiring a content server of the broadcast user to send multiple media streams.

### CROSS-REFERENCE TO RELATED APPLICATIONS

NOT APPLICABLE

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISC APPENDIX

NOT APPLICABLE

### BACKGROUND OF THE INVENTION

This invention relates to communication systems. More particularly, and not by way of limitation, the invention is directed to a system and method of multicasting multimedia streams.

Various applications relating to the broadcast of video and audio over the internet, such as IPTV, online radio, etc. are being used with increased regularity. In contrast to true multimedia conferences or streaming video downloads, applications utilizing the internet to broadcast video and audio are similar to conventional television or radio programming in that the content is streamed to a plurality of viewers at a specified time and date.

In existing systems which implement multimedia services over non-multicast, multimedia servers, registered users are able to join a broadcast stream. However, each incoming user connection is treated as a separate point-to-point connection with the multimedia servers transmitting each packet multiple times to each user.

However, problems arise when portable communications devices having low CPU and power requirements, such as a camera phone or personal data assistants (PDAs) attempt to multicast media to a plurality of users. Oftentimes, these communications devices are not capable of originating multiple unicast streams. For example, users may employ mobile devices for various broadcasting applications, such as video-blogging by mobile users or live multicasting of family events using handheld devices. Furthermore, air-bandwidth is also limited when implementing these applications. For such devices utilizing existing multicasting systems, the network provider must support some mechanism to achieve multicast of multimedia content.

To solve the problems associated with multicasting multimedia contents where a server can only generate one steam, specialized multimedia processors are sometimes deployed in the network. These processors can generate multiple streams to multiple destinations in the target network. However, for use with mobile devices, using specialized multimedia processors are costly for a service provider. It requires the processing of the user's content stream. Specifically, it requires the processing at the application layer. To fund this costly solution, service providers must charge the originating user for such a service. This does not scale well for a large number of content originating users, especially if such a service becomes popular and the multimedia content becomes richer.

Other existing implementations to solve these problems include the use of IP multicast protocol supported by an underlying transport network. This existing system allows scalable multicasting. However, with this solution, the service provider's network must have an IP multicast capability. To deploy such a solution requires end-to-end multicast capability and co-operation from the network operators and equipment from the content producer to the final viewing or listening end user. This solution is not seamless enough with respect to the content provider who would like to deliver content to all users, irrespective of the capabilities of the transport network.

Thus, it would be advantageous to have a system and method of multicasting multimedia content using mobile/portable devices which is inexpensive and scalable. The present invention provides such a system and method.

### BRIEF SUMMARY OF THE INVENTION

In one aspect, the present invention is directed to a system for multicasting a media stream in a telecommunications network. The system includes a broadcast user broadcasting a media stream. The broadcast user determines the destination addresses of each end user desiring to receive the media stream. The media stream is received by an IP router. Within a classification stage of a data-plane residing in the IP router is a replication filter action which replicates the broadcast media stream. The broadcast media stream is replicated with the exception of the destination address. The replicated media stream is sent to each destination address of the viewing or listening end users, thereby providing a multicast media stream to a plurality of end users without requiring a content server of the broadcast user to send multiple media streams.

In another aspect, the present invention is a method of multicasting a media stream in a telecommunications network. The method begins by broadcasting a media stream by a broadcast user. Next, the broadcast user communicates with a plurality of end users. Each end user has a destination address. Next, an additional media stream is requested for each end user. In response, an IP router then replicates the media stream for each end user. Each end user is then sent a replicated media stream.

In another aspect, the present invention is a method of replicating a broadcast media stream in a telecommunications network. Packets of a broadcast media stream are received by an IP router. Next, the IP router determines a list of a plurality of destination addresses to send the broadcast media stream. The received packets are then matched with a replication filter within the IP router. Next, a replication filter action is conducted by the IP router to replicate the receive packets for each destination address. The replicated packets are then sent to each destination address.

In still another aspect, the present invention is an Internet Protocol (IP) router for replicating media streams in a telecommunications network. The IP router receives a broadcast media stream. The IP router determines a plurality of destination addresses to send the broadcast media stream. Within a data-plane having a packet classification stage of the IP router, a replication filter action is conducted for replicating the broadcast media stream for each destination address. The IP router sends the replicated broadcast media stream to each destination address.

In another aspect, the present invention is a content server for multicasting a media stream to a plurality of end users in a telecommunications network. The content server broadcasts a media stream. The content server includes a signaling function which installs a replication filter action in an Internet Protocol (IP) router. The signaling function is triggered in response to receiving a request for receipt of the broadcast media stream to an end user having a destination address. The signaling function also installs the destination address of the end user in the replication filter action in the IP router.

### BRIEF DESCRIPTION OF THE SEVERAL VIEWS OF THE DRAWING

In the following, the features of the invention will be described in detail by showing preferred embodiments, with reference to the attached figures in which:

FIG. 1 is a simplified block diagram of a network in the preferred embodiment of the present invention;

FIG. 2 is a simplified block diagram illustrating an IP router data-plane and its control operations in the preferred embodiment of the present invention;

FIG. 3 is a flow chart illustrates the steps utilized in packet handling within the IP router data-plane according to the teachings of the present invention; and

FIG. 4 is a flow chart illustrating the steps of multicasting a multimedia stream according to the teachings of the present invention.

### DETAILED DESCRIPTION OF THE INVENTION

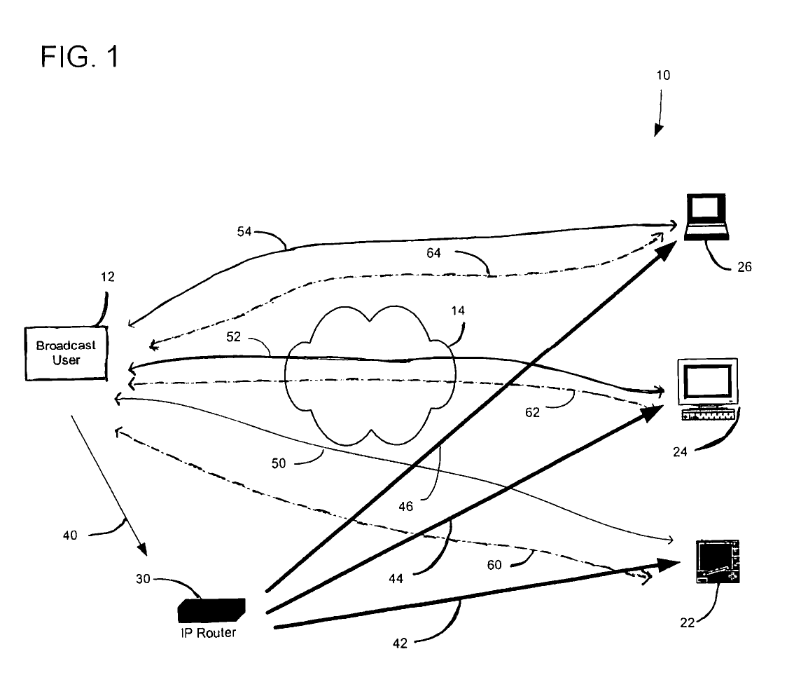

The present invention is a system and method of multicasting multimedia content in a telecommunications network. FIG. 1 is a simplified block diagram of a network 10 in the preferred embodiment of the present invention. A broadcast user 12 communicates via the internet 14 to a plurality of end users 20, 22, and 24. An Internet Protocol (IP) router 30 is utilized to replicate broadcast media from the broadcast user 12 to the end users 20, 22, and 24 (listener/viewers). The end users may be any devise capable of receiving broadcast media via the internet 14. It should be understood that there may be any number of end users and still remain within the scope of the present invention. The broadcast user 12 may be any communication device capable of broadcasting multimedia content. It should be understood that the present invention is relevant only to broadcast services that deliver the exact same multimedia content to the users at a particular time and date, wherein the end users view or listen to the ongoing broadcast content. The present invention is not applicable to applications that allow downloading of multimedia streams at the end user's convenience, since the video server has to replicate different streams to different viewers.

Typically, multimedia streams are transported over IP using User Datagram Protocol (UDP). The control and session set-up packets are carried over Transmission Control Protocol (TCP). One feature of these transported multimedia UDP packets is that the packets which are broadcast to the plurality of end users are identical with the exception of the end user's IP address information (e.g., Destination Address (DA), Destination Port (DP) and Source Port (SP).

In addition in an IP router data-plane, there may be a classification stage having an ordered set of filters. This classification stage is responsible for matching incoming packets against the various configured filters and performing configured operations on the incoming packets. This operation performed on a filter match is denoted as a “filter action.”

The present invention performs a new type of filter action called a replication that causes packets matching the filter to be replicated, but with some IP/UDP fields changed. This new filter action (i.e., replication), when used to match UDP traffic to a specific destination, can replicate the single UDP traffic stream to form multiple streams, but with different IP destination addresses and ports. In the preferred embodiment of the represent invention, the filter associated with the replication process, is installed in the classification stage of the data-plane of the IP router 30 and configured with the list of destination addresses as end users join to watch the broadcast media. The installation is preferably triggered by a session signaling function found in the multimedia server of the broadcast user.

Referring back to FIG. 1, the broadcast user transmits UDP/RTP multimedia streams to the IP router 30 via a link 40. In turn, the IP router 30 broadcasts the UDP/RTP multimedia streams to the plurality of end users 20, 22, and 24 via links 42, 44, and 46. Session signaling/control operations, usually by TCP, is handled over links 50, 52, and 54 between the end users and the broadcast user 12. Additionally, feedback reports of the received multimedia streams are sent from the end users to the broadcast user 12 via links 60, 62, and 64. Typically, session signaling/control (H.225) operations and Real-Time Protocol (RTP) feedback traffic is low-bandwidth. Thus, the signaling functions in the server of the broadcast user 12 can handle this traffic for many users without requiring high performance hardware.

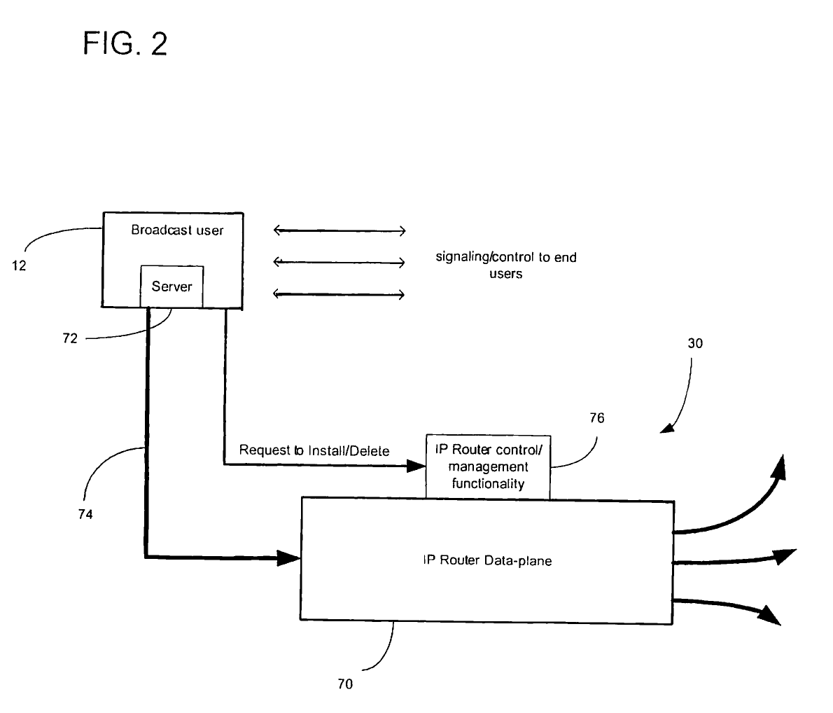

FIG. 2 is a simplified block diagram illustrating an IP router data-plane 70 and control operations in the preferred embodiment of the present invention. A multimedia (audio/video) server 72 within the broadcast user 12 transmits a UDP/RTP multimedia stream 74 to the IP router data-plane 70 of the IP router 30. Several operations are conducted within the IP router data-plane. Ingress decapsulation, packet classification, route lookup and egress decapsulation are performed on the stream 74. Additionally, this filtering stage includes the new filter action (i.e., replication). The multimedia stream 74 is thus replicated into a plurality of multimedia streams identical to the stream 74 with the exception of the destination.

To perform this additional function to replicate, the broadcast user 12 requests to install replication destinations in the classification stage of the IP router data-plane 70. Within an IP router control/management functionality 76 of the IP router 30, the IP router 30 configures the filter within the IP router data-plane to invoke the replication action within the IP router. The creation of this replication filter and its configuration is trigged by the server 72 as end users join and leave a broadcast program. Thus, the management/control functionality 76 preferably exports an application programming interface (API) to enable the content servers to install and configure these filters on demand. Likewise, when desired by the broadcast user 12, the broadcast user may request deletion of the replication action to the IP router control/management functionality 76 of the IP router 30. In addition, the broadcast user 12 also performs signaling/control operations with the plurality of end users 20, 22, and 24.

In the preferred embodiment of the present invention, the multimedia server 72 is modified. A signaling function within the multimedia server 72 of the broadcast user 12 is preferably modified to trigger a request to the IP router control/management functionality 76 to install a new filter (i.e., replicate) for broadcasting of the multimedia stream 74. In addition, the server 72 is modified to provide a request to the control/management functionality 76 of the IP router 30 to install a new destination (i.e., SA, SP, DA, DP,) tuple in the list of viewing or listening users for the replication filter action. It should be understood that when a viewing or listening user joins the broadcast, a source port for the content stream is allocated to that end user, but does not generate the multimedia stream. Rather, only one multimedia stream is sourced per program to the IP router, which performs the replication.

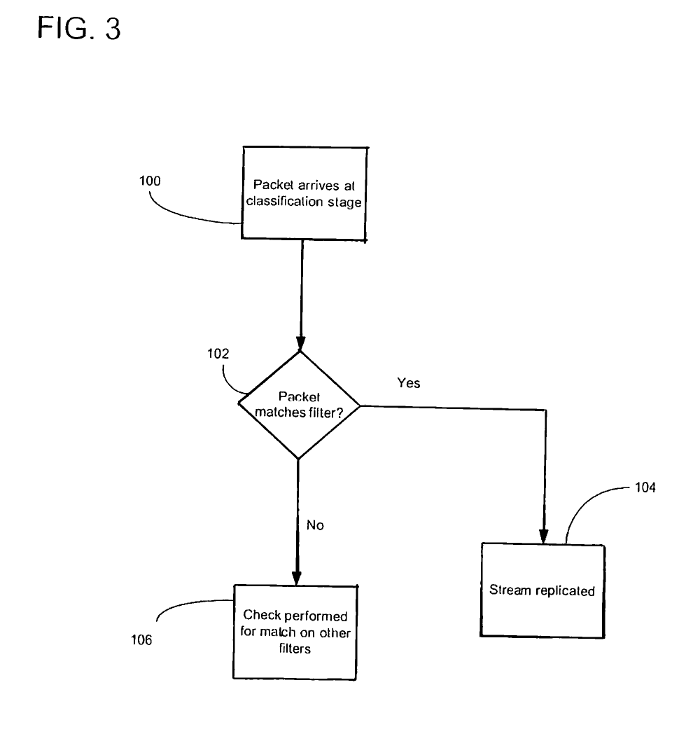

FIG. 3 is a flow chart illustrates the steps utilized in packet handling within the IP router data-plane according to the teachings of the present invention. The method begins in step 100 where a packet of the multimedia stream 74 arrives at the classification stage of the IP router data-plane 70. Next, in step 102, it is determined if the packet (and stream 74) match the replication filter. If it is determined that the packet (stream 74) does not match the filter, the method moves from step 102 to step 104 where a check is performed for a match on any remaining filters of the IP router data-plane 70.

However, in step 102, if it is determined that the packets (and stream 74) do match the replication filter, the method moves from step 102 to step 106 where the stream 74 is replicated. Specifically, identical and new UDP/RTP payload packets are created, but with new destinations in the UDP/IP header fields. For each destination (e.g., SA, SP, DA, DP) on a list of end users, the replication action is performed.

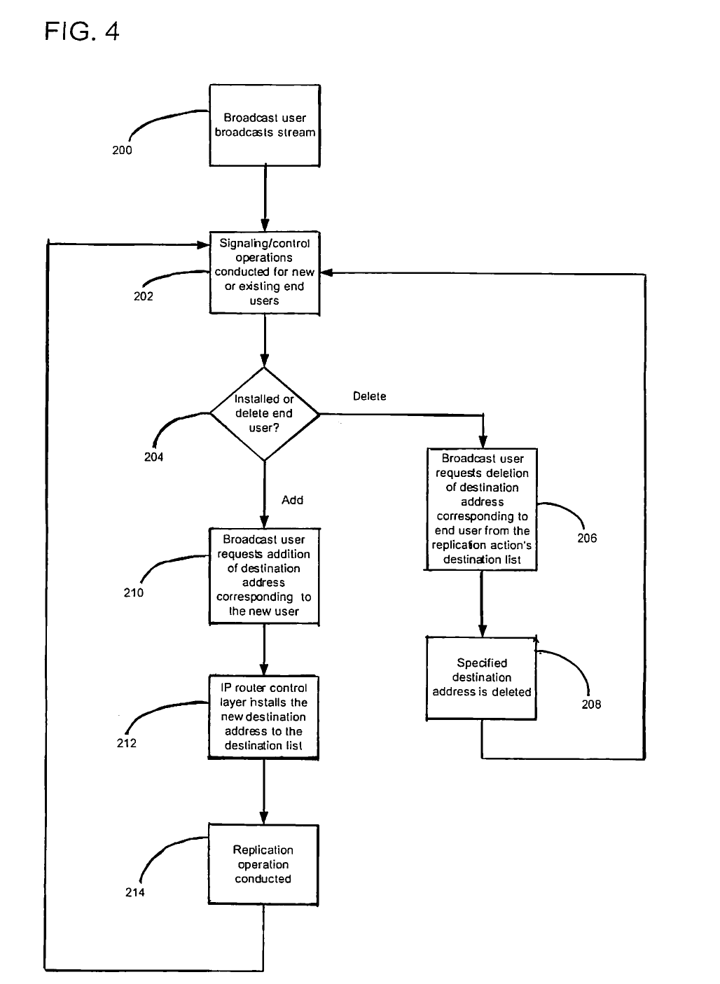

FIG. 4 is a flow chart illustrating the steps of controlling and multicasting a multimedia stream according to the teachings of the present invention. The method begins in step 200 where the broadcast user 12 begins broadcasting a multimedia stream 74. Specifically, the multimedia (audio/video) server 72 within the broadcast user transmits a UDP/RTP multimedia stream 74 to the IP router data-plane 70 of the IP router 30. Next, in step 202, the broadcast user 12 performs signaling/control operations with the plurality of end users 20, 22, and 24 (new or existing viewer/listeners). The signaling and controlling messages sent between the broadcast user and the end users is used to determine which end users desire to receiver the multicast stream 74 and those that desire to discontinue viewing the multimedia stream 74.

The method then moves to step 204 where it is determined if a specific end user is to be installed as a new destination or deleted as a destination of the multimedia stream 74 corresponding to the specific end user. From the signaling and control operations, if it is determined in step 204 that an end user no longer wishes to receive the multimedia stream 74 of the broadcast user 12, the method moves to step 206 where the broadcast user requests deletion of the replication action to the IP router control/management functionality 76 of the IP router 30 for a specified end user. Specifically, the broadcast user 12 requests deletion of the destination address corresponding to the end user from the replication action's destination list in the classification stage of the IP router. Next, in step 208, the control/management functionality 76, in response to the request, deletes the destination address utilized in the replication operation for the specified end user. Specifically, the IP router control layer deletes the destination address from the destination list corresponding to the filter rule configured in the classification state of the dataplane. Thus, the IP router will not replicate towards this destination after it is deleted from the destination list of the replication action. Next, the method then moves to step 202 where the broadcast user continues to perform signaling/control operations with the remaining end users.

However, in step 204, if it is determined that an end user wishes to receive the multimedia stream, the method moves from step 204 to step 210 where the broadcast user 12 requests to install a replication destination for a specified end user in the classification stage of the IP router data-plane 70. Specifically, the broadcast user requests the addition of the destination address corresponding to the new end user to the “replication action” in the classifier in the IP router. The method then moves to step 212 wherein the IP router control/management functionality 76 of the IP router 30 configures the filter within the IP router data-plane to invoke the replication action within the IP router. The management/control functionality 76 preferably exports an API to enable the content server 72 to install and configure these filters on demand. Specifically, the control layer of the IP router installs the new destination address to the destination list corresponding to the filter rule configured in the classification stage of the dataplane. Next, in step 214, the IP router performs the replication operation. In the preferred embodiment of the present invention, the IP router dataplane, while forwarding traffic, performs the replication of the UDP/IP multimedia packets to new destinations. Several operations are conducted within the IP router data-plane. Ingress decapsulation, packet classification, route lookup and egress decapsulation are performed on the stream 74. Additionally, this filtering stage includes the new filter action (i.e., replication of the stream). The multimedia stream 74 is thus replicated into a plurality of multimedia streams identical to the stream 74 with the exception of the destination. Specifically, identical and new UDP/RTP packets are created, but with different destinations. For each destination (e.g., DA, DP, SP) on a list of end users, the replication action is performed. Thus, the multimedia stream is multicast to a plurality of end users. The multimedia stream 74 continues to be replicated until a deletion or addition of destinations is requested. Thus, the method then moves from step 214 to step 202 where the broadcast user continues to perform signaling/control operations with the remaining end users.

The present invention provides a simple and innovative method and system of offloading the replication of video/audio UDP streams from low power or low bandwidth multimedia content generation devices, such as mobile phones or other portable communication devices, onto the IP routing data-plane. The IP routing data-plane is designed to handle line rate traffic and includes adequate processing power to perform the replication process. Since the replication of multimedia streams to a plurality of end users is conducted at the networking layer, there is no requirement for the use of expensive hardware (e.g., multimedia processors), located in the service provider's network, to process at the application layer. In addition, the present invention avoids the need for providing true multicast capability in the transport IP network.

Although preferred embodiments of the present invention have been illustrated in the accompanying drawings and described in the foregoing Detailed Description, it is understood that the invention is not limited to the embodiments disclosed, but is capable of numerous rearrangements, modifications, and substitutions without departing from the scope of the invention. The specification contemplates all modifications that fall within the scope of the invention defined by the following claims.

What is claimed is:

1. A method of multicasting a media stream in a telecommunications network, the method comprising the steps of:
broadcasting a media stream;
communicating with a plurality of end users, each end user having a destination address;
requesting an additional media stream for each end user;
replicating the media stream to provide a broadcast media stream to each end user; and
sending a replicated media stream to the destination address of each end user.

2. The method of multicasting a multimedia stream of claim 1 wherein the media stream is replicated within an Internet Protocol (IP) router.

3. The method of multicasting a multimedia stream of claim 2 wherein the step of replicating the media stream includes performing a replication filter action in a data-plane of the IP router.

4. The method of multicasting a multimedia stream of claim 3 wherein the replication filter action is conducted in a packet classification stage of the data-plane of the IP router.

5. The method of multicasting a multimedia stream of claim 4 wherein the replication filter action includes creating an identical media stream with a specific destination address for each end user.

6. The method of multicasting a multimedia stream of claim 1 further comprising the steps of:
communicating with an additional end user having a destination address;
requesting an additional media stream for the additional end user;
replicating the media stream to provide a broadcast media stream to the additional end user; and
sending a replicated media stream to the destination address of the additional end user.

7. The method of multicasting a multimedia stream of claim 1 further comprising the steps of:
communicating with at least one of the plurality of end users;
determining that one of the plurality of end users no longer desires to receive the media stream;
requesting a deletion of one of the replicated media streams of the end user no longer desiring to receive the media stream; and
removing the destination address from a list of destination addresses of replicated media steams.

8. A system of multicasting a media stream within a telecommunications network, the system comprising:
a broadcast user broadcasting a media stream;
means for the broadcast user to communicate with a plurality of end users, each end user having a destination address;
means for replicating the media stream for each end user, and
means for delivering the media stream to the destination address of each end user.

9. The system of multicasting a media stream within a telecommunications network of claim 8 wherein the means for replicating the media stream for each user is located within an Internet Protocol (IP) router.

10. The system of multicasting a media stream within a telecommunications network of claim 9 wherein the means for delivering the media stream for each user is located within the Internet Protocol (IP) router.

11. The system of multicasting a media stream within a telecommunications network of claim 10 wherein the means for replicating the media is a replication filter action in a data-plane of the IP router.

12. The system of multicasting a media stream within a telecommunications network of claim 11 wherein the replication filter action is conducted in a packet classification stage of the data-plane of the IP router.

13. The system of multicasting a media stream within a telecommunications network of claim 12 wherein the replication filter action includes means for creating an identical media stream with a specific destination address for each end user.

14. The system of multicasting a media stream within a telecommunications network of claim 8 further comprising:
means for determining if an additional end user having a destination address desires to receive the media stream;
responsive to determining if an additional end user desires to receive the media stream, means for replicating the additional media stream; and
means for delivering the additional media stream to the destination address of the additional end user.

15. The system of multicasting a media stream within a telecommunications network of claim 8 further comprising:
means for determining if one of the end users no longer desires to receive the media stream;
responsive to determining if one of the end user no longer desires to receive the media stream means for deleting the destination address from a list of destination addresses of replicated media steams.

16. A method of replicating a broadcast media stream in a telecommunications network, the method comprising the steps of:
receiving packets of the broadcast media stream;
determining a list of a plurality of destination addresses to send the broadcast media stream;
matching the received packets with a replication filter;
conducting a replication filter action to replicate the receive packets for each destination address;
sending the replicated packets to each destination address.

17. The method of replicating a broadcast media stream of claim 16 wherein the method is conducted within an Internet Protocol (IP) router.

18. The method of replicating a broadcast media stream of claim 17 wherein the replication filter action is located within a data-plane of the IP router.

19. The method of replicating a broadcast media stream of claim 18 wherein the step of conducting a replication filter action includes:
replicating the received packets for each destination address; and
changing a destination of the replicated packets to one of the plurality of destination addresses.

20. An Internet Protocol (IP) router for replicating media streams in a telecommunications network, the IP router comprising:
means for receiving a broadcast media stream;
means for determining a plurality of destination addresses to send the broadcast media stream;
a data-plane having a packet classification stage;
means within the data-plane for replicating the broadcast media stream for each destination address; and
means for sending the replicated broadcast media stream to each destination address.

21. The IP router for replicating media steams in a telecommunications network of claim 20 wherein the classification stage includes a filter action for replicating a media stream, the filter action replicating the media stream with the exception of the destination address.

22. The IP router for replicating media steams in a telecommunications network of claim 21 further comprising means for enabling a broadcast server to install and configure the filter action for replicating the media stream for each destination address on demand.

23. The IP router for replicating media steams in a telecommunications network of claim 22 wherein the means for enabling a broadcast server to install and configure the filter action for replicating the media stream includes an application programming interface (API) exported to the broadcast server.

24. A content server for multicasting a media stream to a plurality of end users in a telecommunications network, the content server comprising:
means for broadcasting a single media stream; and
a signaling function to install a replication filter action in an Internet Protocol (IP) router, the signaling function being triggered in response to receiving a request for receipt of the broadcast media stream to an end user having a destination address;
the signaling function installing the destination address of the end user in the replication filter action in the IP router.

25. The content server for multicasting a media stream to a plurality of end users wherein the content server allocates a single source port for the media stream for the plurality of end users.
